(19) United States
(12) Patent Application Publication
(10) Pub. No.: US 2007/0103886 A1
(43) Pub. Date: May 10, 2007

(54) Combination phone and flashlight and method therefor

(76) Inventor: Robert William Collins, Las Vegas, NV (US)

Correspondence Address: WEISS & MOY PC, 4204 NORTH BROWN AVENUE, SCOTTSDALE, AZ, 85251, US

(21) Appl. No.: 11/271,320

(22) Filed: Nov. 10, 2005

(51) Int. Cl. H04M 1/22

(52) U.S. Cl. 362/88; 362/253

(57) ABSTRACT

A lighting device uses a wireless telephone. A lighting circuit is stored within the wireless telephone for allowing the wireless telephone to function as a flashlight.

### FIELD OF THE INVENTION

This invention relates to wireless devices and, more specifically, to a combination wireless telephone/cellular phone and a flashlight.

### BACKGROUND OF THE INVENTION

In times of emergency, one item that most people generally require is a flashlight. During major storms when electrical power is disrupted, people are always searching for a flashlight in order to see their surroundings. In a like manner, people who are involved in accidents such as an automobile crash, a train or airline crash and the like generally require the use of a flashlight. The people involved in these situations are always looking for a flashlight in order to view their surrounds and to survey the damage. This is especially true if the accident occurs at night and/or in a remote location.

While many people may have a flashlight at home, most people do not carry a flashlight with them when they travel or stored one in their automobile. Even if a person has a flashlight in the house or automobile, many times the flashlight will not work. This is generally due to the batteries in the flashlight no longer having sufficient power to illuminate the bulb. Most people rarely check the batteries in the flashlight and only find out that the batteries are drained when the person tries to use the flashlight.

Therefore, a need existed to provide a device and method to overcome the above problem. The device and method must overcome the problems associated with prior art devices and methods.

### SUMMARY OF THE INVENTION

In accordance with one embodiment of the present invention, a lighting device is disclosed. The lighting device has a wireless telephone. A lighting circuit is stored within the wireless telephone for allowing the wireless telephone to function as a flashlight.

In accordance with another embodiment of the present invention, a lighting device is disclosed. The lighting device has a cellular telephone. A lighting circuit is stored within the cellular telephone for allowing the cellular telephone to function as a flashlight. The lighting circuit has a lighting element. An activation switch is coupled the lighting element and housed in the cellular telephone. A power supply is coupled to the lighting element and the activation switch and stored within the cellular telephone to power the lighting circuit. A lens is coupled to the body of the cellular telephone to cover the lighting element.

The present invention is best understood by reference to the following detailed description when read in conjunction with the accompanying drawings.

### BRIEF DESCRIPTION OF THE DRAWINGS

FIG. 1 is a front view of one embodiment of the present invention;

FIG. 2 is an elevated perspective view of a second embodiment of the present invention;

FIG. 3 is an elevated perspective view of a third embodiment of the present invention;

FIG. 4 is an elevated perspective view of a forth embodiment of the present invention;

FIG. 5 is one embodiment of the lighting circuit used in the present invention; and

FIG. 6 is another embodiment of the lighting circuit used in the present invention.

Common reference numerals are used throughout the drawings and detailed description to indicate like elements.

### DETAILED DESCRIPTION

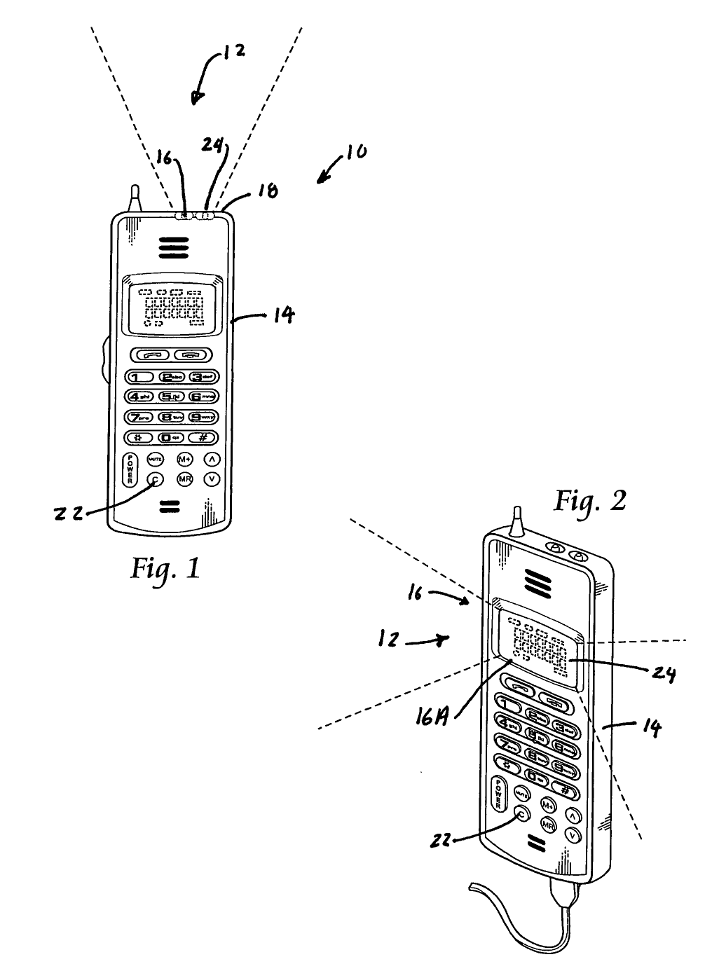

Referring to FIG. 1, a combination wireless phone and flashlight 10 is shown. The combination wireless phone and flashlight 10 over comes the problem associated with prior art devices. Since a majority of people carry wireless phones, the present invention will solve the problem of not having a flashlight in times of emergency. Furthermore, since most wireless phones use rechargeable batteries, the present invention will solve the problem of the flashlight not working due to having batteries that no longer having sufficient power to illuminate the light bulb. In the embodiment depicted in FIG. 1, the combination wireless phone and flashlight 10 is a cellular phone. However, this should not be seen as to limit the scope of the present invention.

As can be seen in FIG. 1, the combination wireless phone and flashlight 10 will incorporate a lighting circuit 12 within a body of a wireless phone 14. The lighting circuit 12 will allow one to use the combination wireless phone and flashlight 10 as a flashlight when required. The lightening circuit 12 will have an illuminating element 16. As shown in FIG. 1, the illuminating element 16 is positioned on the top surface 18 of the body of a wireless phone 14. However, this is only shown as an example. The illuminating element 16 may be positioned on any of the sides of the wireless phone 14.

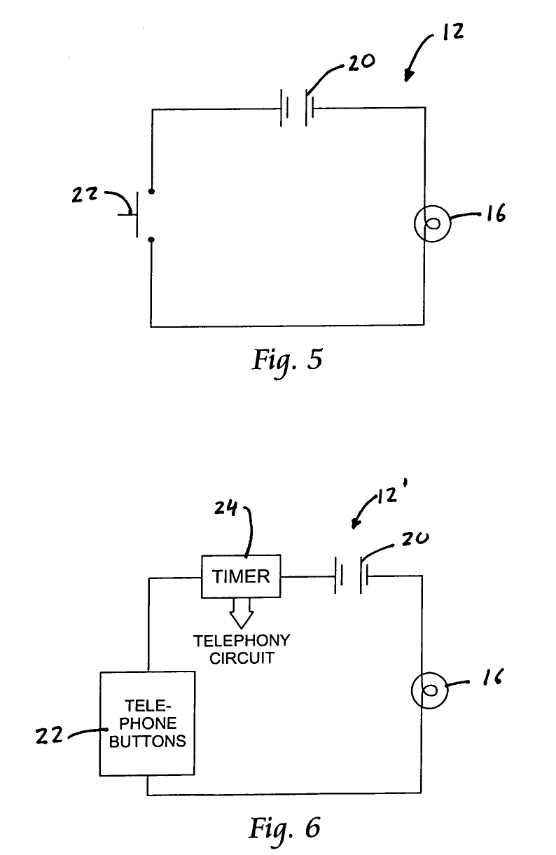

Referring to FIG. 5, one embodiment of the lighting circuit 12 is shown. The lighting circuit 12 is generally comprised of the illuminating element 16, a power supply 20 and an activation/deactivation button 22. The illumination element 16 is generally a light bulb, light emitting diode, HID bulb, or the like. The listing of the above should not be seen as to limit the scope of the present invention. Other types of illumination elements 16 may be used without departing from the spirit and scope of the present invention. The illumination element 16 is positioned in the body of the wireless phone 14. As shown in FIG. 1, the illumination element 16 is housed such that the main bulb section of the illumination element 16 is positioned out of the body of the wireless phone 14 and exposed. In the embodiment depicted in FIG. 1, the illuminating element 16 is positioned on the top surface 18 of the body of a wireless phone 14. However, this is only shown as an example. The illuminating element 16 may be positioned on any of the sides of the wireless phone 14. A plastic cover/lens 24 may be used to cover the illuminating element 16. The plastic cover/lens 24 is used to protect the illuminating element 16 from being damaged and breaking. The plastic cover/lens 24 may further be used to focus the light beam emanating from the illuminating element 16.

The illuminating element 16 is coupled to a power supply 20. The power supply 20 is used to power the lighting circuit 12 thereby illuminate the illuminating element 16. The power supply 20 is generally the power supply of the wireless phone 14. The power supply 20 is preferably a rechargeable battery.

An activation/deactivation button 22 is coupled to the illuminating element 16 and to the power supply 20. The activation/deactivation button 22 is used to activate and deactivate the illuminating element 16. In the embodiment depicted in FIG. 5, the activation/deactivation button 22 is a new button placed on the wireless phone 14.

Referring now to FIG. 6, another embodiment of the lighting circuit 12′ is shown. In this embodiment, the lighting circuit 12′ is similar to that shown in FIG. 5. The main difference is that the activation/deactivation button 22 is an existing button on the wireless phone 14. If the activation/deactivation button 22 is an existing button on the wireless phone 14, the activation/deactivation button 22 is coupled to a timing module 24. If the activation/deactivation button 22 is pressed for a predetermined amount of time, the timing module 24 will send a signal which activates/deactivates the illuminating element 16. However, if the activation/deactivation button 22 is pressed for a timeframe shorter than that set by the timing module 24, the activation/deactivation button 22 will function as a normal wireless phone button. The lighting circuit 12′ may be designed so that all existing keys are coupled to the timing module 24 and will thus activate/deactivate the illuminating element 16. Alternatively, the lighting circuit 12′ may be designed so that one specific existing key is coupled to the timing module 24 and will thus activate/deactivate the illuminating element 16 (i.e., the #5 key on the keypad).

Referring to FIG. 2, another embodiment of the combination wireless phone and flashlight 10′ is shown. The combination wireless phone and flashlight 10′ is similar to that shown in FIG. 1. The main difference is that the display panel 16A is used as the illuminating element 16. Most display panels 16A on wireless phone 14 do not illuminate sufficient to be used as a flashlight. However, by incorporating the lighting circuit 12 or 12′ into the display panel 16A, the display panel 16A could be used as a flashlight. In this embodiment, the illuminating element 16 may have different wattages. For a first wattage, the illuminating element will illuminate the display panel 16A so that one may read the display panel 16. A second wattage is used when the lighting circuit 12 or 12′ is activated thereby allowing the display panel 16A to be used as a flashlight.

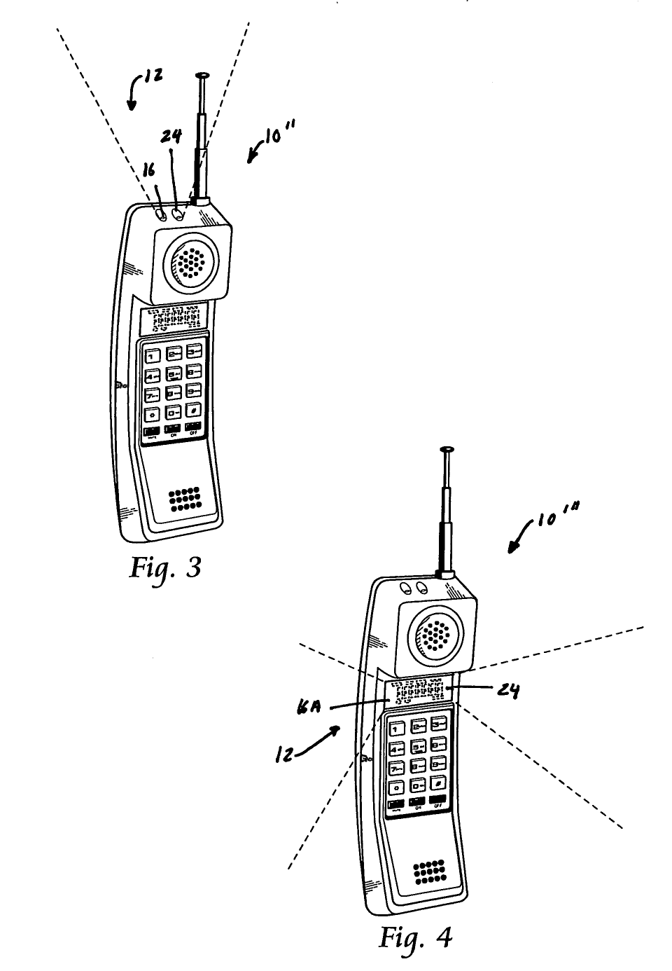

Referring to FIG. 3, another embodiment of the combination wireless phone and flashlight 10″ is shown. In this embodiment, the combination wireless phone and flashlight 10″ is similar to that shown in FIG. 1. The only difference is that the wireless phone 14 is a cordless home/office phone.

Referring to FIG. 4, another embodiment of the combination wireless phone and flashlight 10′″ is shown. In this embodiment, the combination wireless phone and flashlight 10′″ is similar to that shown in FIG. 2. The only difference is that the wireless phone 14 is a cordless home/office phone.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A lighting device comprising:
a wireless telephone; and
a lighting circuit stored within the wireless telephone for allowing the wireless telephone to function as a flashlight.

2. A lighting device in accordance with claim 1 wherein the lighting circuit comprises:
a lighting element;
an activation switch coupled to the lighting element and housed within the wireless telephone; and
a power supply stored within the wireless telephone and coupled to the lighting element and the activation switch.

3. A lighting device in accordance with claim 2 further comprising a lens to cover the lighting element.

4. A lighting device in accordance with claim 2 wherein the lighting element is housed in a body of the wireless telephone and positioned so that a top section of the lighting element is positioned out of the body and is exposed.

5. A lighting device in accordance with claim 2 wherein the lighting element is housed in a display panel of the wireless telephone.

6. A lighting device in accordance with claim 2 wherein the activation switch is a dedicated switch used only to activate and deactivate the lighting circuit.

7. A lighting device in accordance with claim 1 wherein the lighting circuit comprises:
a lighting element;
at least one activation button coupled to the lighting element, the activation button being an existing button on the wireless telephone;
a power supply stored within the wireless telephone and coupled to the lighting element and the at least one activation button for powering the lighting circuit;
a timing module coupled to the at least one activation button, wherein pressing of the at least one activation button for a predetermined time period will one of activate or deactivate the lighting circuit, pressing of the at least one activation button for less than the predetermined time period allowing the at least one activation button to function as an existing wireless phone button.

8. A lighting device in accordance with claim 7 further comprising a lens to cover the lighting element.

9. A lighting device in accordance with claim 7 wherein the lighting element is housed in a body of the wireless telephone and positioned so that a top section of the lighting element is positioned out of the body and is exposed.

10. A lighting device in accordance with claim 7 wherein the lighting element is housed in a display panel of the wireless telephone.

11. A lighting device in accordance with claim 1 wherein the wireless telephone is a cellular telephone.

12. A lighting device in accordance with claim 1 wherein the wireless telephone is a cordless telephone.

13. A lighting device comprising:
a cellular telephone; and
a lighting circuit stored within the cellular telephone for allowing the cellular telephone to function as a flashlight, the lighting circuit comprises:
a lighting element;
an activation switch coupled to the lighting element and housed in the cellular telephone;
a power supply stored within the cellular telephone and coupled to the lighting element and the activation switch; and
a lens to cover the lighting element.

14. A lighting device in accordance with claim 13 wherein the lighting element is housed in a body of the cellular telephone and positioned so that a top section of the lighting element is positioned out of the body and is exposed.

15. A lighting device in accordance with claim 13 wherein the lighting element is housed in a display panel of the cellular telephone.

16. A lighting device in accordance with claim 13 wherein the activation switch is a dedicated switch used only to activate and deactivate the lighting circuit.

17. A lighting device in accordance with claim 13 wherein the lighting circuit further comprises:
a timing module coupled to the activation button;
wherein the activation button is an existing button on the cellular telephone, pressing of the at least one activation button for a predetermined time period will one of activate or deactivate the lighting circuit, pressing of the at least one activation button for less than the predetermined time period will allow the at least one activation button to function as the cellular telephone existing button.

18. A lighting device comprising:
a cellular telephone; and
a lighting circuit stored within the cellular telephone for allowing the cellular telephone to function as a flashlight, the lighting circuit comprises:
a lighting element;
an activation switch coupled to lighting element and housed in the wireless telephone;
a power supply coupled to the lighting element and the activation switch and stored within the cellular telephone;
a lens to cover the lighting element; and
a timing module coupled to the activation button;
wherein the activation button is an existing button on the cellular telephone, pressing of the at least one activation button for a predetermined time period will one of activate or deactivate the lighting circuit, pressing of the at least one activation button for less than the predetermined time period will allow the at least one activation button to function as the cellular telephone existing button.

19. A lighting device in accordance with claim 18 wherein the lighting element is housed in a body of the cellular telephone and positioned so that a top section of the lighting element is positioned out of the body and is exposed.

20. A lighting device in accordance with claim 18 wherein the lighting element is housed in a display panel of the cellular telephone.
